(19) United States
(12) Patent Application Publication
(10) Pub. No.: US 2015/0135668 A1
(43) Pub. Date: May 21, 2015

(54) FILTER MEDIUM CONSISTING OF SYNTHETIC POLYMER

(71) Applicant: IREMA FILTER GmbH, Postbauer-Pavelsbach (DE)

(72) Inventor: Andreas Seeberger, Nuremberg (DE)

(21) Appl. No.: 14/407,630

(22) PCT Filed: May 16, 2013
(86) PCT No.: PCT/EP2013/001463

§ 371 Date: Dec. 12, 2014

(30) Foreign Application Priority Data
Jun. 14, 2012 (DE) 10 2012 011 900.3

(51) Int. Cl. B01D 39/16; B01D 46/00

(52) U.S. Cl. CPC B01D 39/163; B01D 46/0032
USPC 55/528

(57) ABSTRACT

The invention relates to a filter medium consisting of a synthetic polymer, comprising a first layer of a non-woven produced by means of a melt-spinning method. An electrostatic charge can be applied to said first layer of a non-woven and the polymer has a melt-flow-Index between 20-200, preferably between 40-100 and even more preferably from 60, the non-woven layer has, in particular, a soft texture.

The invention relates to a filter medium made from synthetic polymer having a first layer of nonwoven produced in a melt-spinning process.

Nonwoven filter media of this type are used in filters, e.g. in air filters and air conditioning systems, particularly however in air filters for motor vehicle interiors or engines.

Nonwoven fabrics are usually produced in a primary forming method using a melt-spinning process such as, for example, a spun-bond or a melt-blown process as described e.g. in DE 41 23 122 A1.

The intake air of internal combustion engines, for example in motor vehicles or in off-road applications, is normally filtered to protect the engine's combustion chamber from mechanical damage due to particles sucked in from the ambient air. An important design criterion for filter elements is ensuring long filter service life along with concurrently high effective filtration of ingested particles.

Then again, however, motor vehicles have a precisely calculated energy distribution system. Only limited amounts of energy are provided for heating/ventilation/cooling. Due to ever stricter exhaust regulations, these energy quantities continually need to be markedly reduced, particularly also in the case of electric vehicles in which, to the greatest extent possible, mechanical energy is only to be expended for drive propulsion. There are also narrow limits governing the costs of vehicle components. On the other hand, vehicle buyers are continually demanding greater comfort and safety. From these perspectives, particle filters having the lowest possible loss or difference in pressure are of special significance as the fan motor only needs to generate lower pressure, with energy consumption consequently being less. Moreover, due to the lesser amount of power required, they also run more quietly which reduces noise and thus considerably increases driving comfort.

The demand for filter systems having low pressure differentials competes with the required filtration efficiency and the required service life; i.e. the amount of time expressed in mileage which a filter can remain in the vehicle before needing to be replaced.

For example, pollen filters which only filter pollen out of the air flowing into the vehicle are insufficient for vehicle interiors. The allergens which cause the immune system of allergy sufferers to react are proteins having diameters of only a fraction of the diameter of pollen. They are in the 0.1 micrometer range; i.e. the range which is most problematic for particle filters, the so-called MPPS (Most Penetrating Particle Size). Correspondingly, effective filtration at this size should be at least 50%, whereby this is measured by means of an aerosol having particles of roughly the same density, e.g. sodium chloride. At the same time, the service life of such filters installed into motor vehicles should be at least 30,000 kilometers.

In common filters, e.g. ring filters or frame filters, the filter material has a zigzag folding; i.e. pleating. The use of spacers is known in order to prevent adjacent filter surfaces in such a pleating from falling on each other and thereby reducing the surface exposed to the flow. Such spacers are usually obtained by embossing the filter material. However, satisfactory texturing is only possible in the case of paper filters. In contrast, PP, PET or polyester filters emboss very poorly, if at all.

The selective use of additional electrostatic separating mechanisms offers the possibility of increasing filtration efficiency within the MPPS range while retaining an acceptable pressure loss. Electret filters have the additional electrostatic component; i.e. additionally to mechanical separating mechanisms such as interception, inertia or impaction, diffusion and gravity particles are also separated by coulomb, dipole and image charge forces. Doing so enables considerable improvements in filtration efficiency.

As described in U.S. Pat. No. 6,524,360 B2, electret filter media are usually produced by extruding a polymer. A corona discharge or triboelectric process is used to electrostatically charge the filter medium. A corona discharge method for electrostatically charging an electret filter medium is known for example from U.S. Pat. No. 4,588,537.

The addition of additives, e.g. fluorine compounds as described in U.S. Pat. No. 6,808,551 B2, is further known to improve the electrostatic effect of the electret filter medium.

However, common electret filters have low charge stability, which results over time in limiting of the electrostatic effect in the filtration phase. Common electret filters further lose their electrostatic effect when exposed to moisture.

The object of the invention is that of providing a filter medium having long service life and high filtration efficiency.

This object is accomplished by a filter medium in accordance with claim 1 and a filter in accordance with claim 22.

The filter medium according to the invention has the advantage of a low pressure differential; i.e. the pressure loss at a defined flow rate. The inventive filter medium further has a high static charge capacity, whereby the electrostatic effect is particularly pronounced. The high electrostatic effect yields higher efficiency at lower pressure loss. While a filter medium with nanofibers achieves effective filtration of approximately 80% at a pressure differential of 110 Pa (Pascal), the inventive filter medium achieves effective filtration of 80% at a pressure differential of just 60 Pa. Furthermore, the inventive filter medium is rechargeable; i.e. the electrostatic effect is regenerable if static charge is lost due to long service life or e.g. exposure to moisture.

A nonwoven as defined by the invention is a non-woven fabric where fiber strands are deposited on top of each other in a primary forming method and bond into a nonwoven. If necessary, hardening follows in a further step through calandering, thermobonding, hot air and/or ultrasonic sealing.

A polymer in the terms of the invention is pure polymer or a polymer blend. Same in particular exhibits a characteristic molecular chain length distribution and/or a characteristic molecular structure.

Air permeability in the terms of the invention is that volume per square meter which flows through a nonwoven fabric per second at 200 Pa incident flow. Mass density and mass per unit area in terms of the invention refers to the area-related mass and is in particular determined pursuant to the DIN EN 29073-1.

Application of charge in the terms of the invention means that a layer, or a filter medium respectively, can be electrostatically charged for a long period of time, particularly at least a plurality of days or months, and particularly that electrical charge can be stored on the layer or filter medium.

Average pore size in the terms of the invention is determined based on the bubble point test pursuant to the ASTM D6767, ASTM F316-0 and/or ISO 2942, ISO 4003 standards, particularly with the Topas PSM 65 analyzer.

Filtration efficiency as defined by the invention is determined using NaCl particles, particularly of a size from 0.3 μm to 0.5 μm and pursuant to DIN 71460-1, at a flow rate of 0.14 m/s.

A fiber bundle in the terms of the invention consists of a plurality of fiber strands.

Interlacing in the terms of the invention means that the fibers of two nonwoven layers are so comingled and interwound that the two nonwoven layers are permanently joined together.

Preferential embodiments are set forth in the subclaims.

In one preferential embodiment, the provision of softness, elasticity, compressibility, burst strength to penetrating bodies, thickness, mass density, abrasion and/or tensile strength pursuant a tensile test of the first layer of nonwoven is such that at least one surface of the first layer of nonwoven exhibits fleecy haptics.

Tests have shown that a filter medium having a first layer of nonwoven with fleecy haptics considerably increases the electrostatic capacity of the filter medium, which increases the filtration efficiency due to the electrostatic effect of the filter medium.

In a further preferential embodiment, the filtration efficiency of the first layer of nonwoven prior to applying the charge amounts substantially to 5% to 50%, preferably 10% to 30%, preferably 15% to 20%, and after applying the static charge, substantially to 50% to 95%, preferably 60% to 90%, more preferably 70 to 80% and most preferably 75%.

In a further preferential embodiment, the first layer of nonwoven has a mass density of approximately 35 to 60 g/m², preferably approximately from 40 to 55 g/m², particularly preferably approximately from 45 to 50 g/m² and most preferably approximately 47.5 g/m².

In a further preferential embodiment, the first layer of nonwoven has a thickness of approximately from 0.4 mm to 0.7 mm, preferably approximately from 0.5 mm to 0.6 mm and most preferably approximately 0.55 mm.

The above ranges of mass and thickness values have proven to be particularly advantageous with respect to the filter medium's service life and differential pressure.

In a further preferential embodiment, the first layer of nonwoven has an air permeability of approximately 800 l/m² s to 1300 l/m² s, preferably approximately from 900 l/m² s to 1200 l/m² s, and most preferably approximately 1000 l/m² s.

In a further preferential embodiment, the first layer of nonwoven has an average pore size of from more than 10 μm to 60 μm, preferably from 20 μm to 50 μm, preferably from 30 to 40 μm, and most preferably 35 μm.

In a further preferential embodiment, the first layer of nonwoven is produced at a polymer processing temperature of approximately 230° C. to 280° C., preferably approximately of from 240° C. to 270° C., and most preferably approximately from 250° C. to 260° C.

Such processing temperature has proven to be particularly advantageous with respect to polymers having the claimed melt flow index.

In a further preferential embodiment, 50% to 100% and preferably 80% to 90% of the fibers of the first layer are arranged in fiber bundles of at least two fibers.

The fiber bundles impart increased rigidity to the first layer of nonwoven, thereby increasing its pleatability. The fiber bundles also further impart increased internal stability to the first layer of nonwoven, whereby it will not collapse even given high flow rates. Doing so thus ensures the open porosity and thus lower pressure differential to the nonwoven.

In a further preferential embodiment, the first layer exhibits a volume density between 0.01 g/cm³ and 0.12 g/cm³, preferably between 0.03 g/cm³ and 0.1 g/cm³ and most preferably 0.07 g/cm³.

The low density heightens the haptic effect of the fluffiness to the nonwoven of the first layer, whereby the electrostatic capacity is further increased and the pressure differential stays at a low level.

In a further preferential embodiment, the fibers of the first layer predominantly have a thickness of from 3 μm to 10 μm and preferably from 4 μm to 5 μm.

The relatively large fiber thickness, e.g. compared to a filter medium of nanofibers, makes the inventive filter medium relatively easy to manufacture. The spray nozzles in a spin beam for greater fiber thickness are substantially less temperamental and also other disruptive factors have less impact on a production process for fibers of larger fiber thickness.

According to a further preferential embodiment, the filter medium has a second layer of nonwoven for stabilization, particularly for producing pleatability.

Due to the softness of the first layer's lesser thickness, providing the filter medium with this second layer can be necessary in certain applications. The second layer does not need to have any or at least only minimal filtering properties. It primarily serves to stabilize the first layer of the filter medium.

This is also reflected by the second layer in a further preferential embodiment having a higher volume density, (particularly) preferably of from 0.12 to 0.2 g/cm³ and even more preferably from 0.15 to 0.18 g/cm³.

In a further advantageous embodiment, fibers of the first layer of nonwoven and fibers of the second layer of nonwoven are interlaced together in a boundary layer.

The interlacing of the fibers, which preferably already occurred during the primary forming process, adheres the first and the second layer together without the need for any further means.

In a further advantageous embodiment, the second layer exhibits thicker fibers than the first layer, particularly at a fiber thickness of from 7 μm to 25 μm, preferably from 10 μm to 20 μm, and particularly preferably 15 μm to 18 μm.

The second layer has higher stability due to the thicker fibers.

In a further advantageous embodiment, conceivable for the synthetic first and/or second polymer is at least one polymer, particularly a polyester, selected from among the group of polyethylene (PE), polyethylene terephthalate (PET), polycarbonate (PC), polyamide (PA), polybutylene terephthalate (PBT), polypropylene (PP) and/or polyvinyl chloride (PVC).

In a further advantageous embodiment, 50% to 100%, preferably 80% to 100%, and particularly preferably 80% to 90% of the fibers of the first layer and/or second layer are arranged in fiber bundles of at least two fibers.

In a further advantageous embodiment, the first layer and/or the second layer have fiber bundles of different synthetic polymer fibers.

Forming bundles from fibers of different synthetic polymers can further increase the electrostatic capacity of the material.

In a further advantageous embodiment, the individual fibers and/or the fiber bundles of the first layer and/or second layer are arranged predominantly parallel.

In a further advantageous embodiment, the first layer and/or second layer is hydrophobic.

In a further advantageous embodiment, the first layer and/or second layer is designed such that the filter medium has a differential pressure of less than 70 Pa, preferably of less than 60 Pa.

In accordance with the invention, a plurality of the embodiments of the invention as described above can also be grouped together in any combination.

The above as well as further advantages, features and possible applications of the present invention follow from the description of preferred embodiments below in reference to the drawings, which show the following:

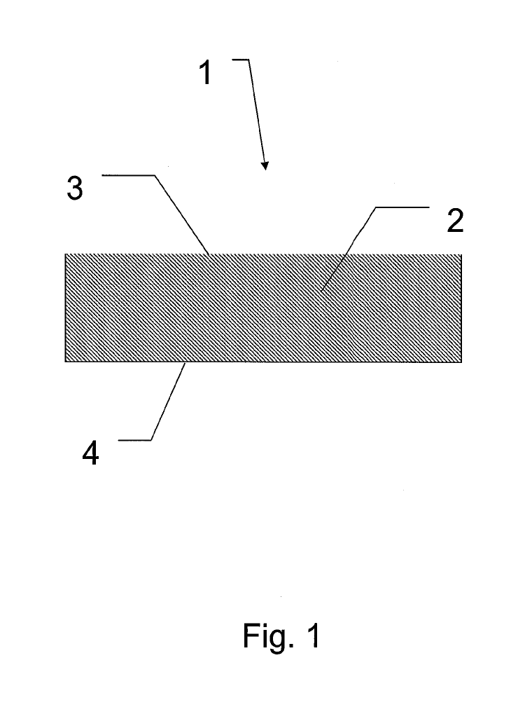

FIG. 1 is a partly schematic representation of a cross section through a filter medium according to a first embodiment of the invention;

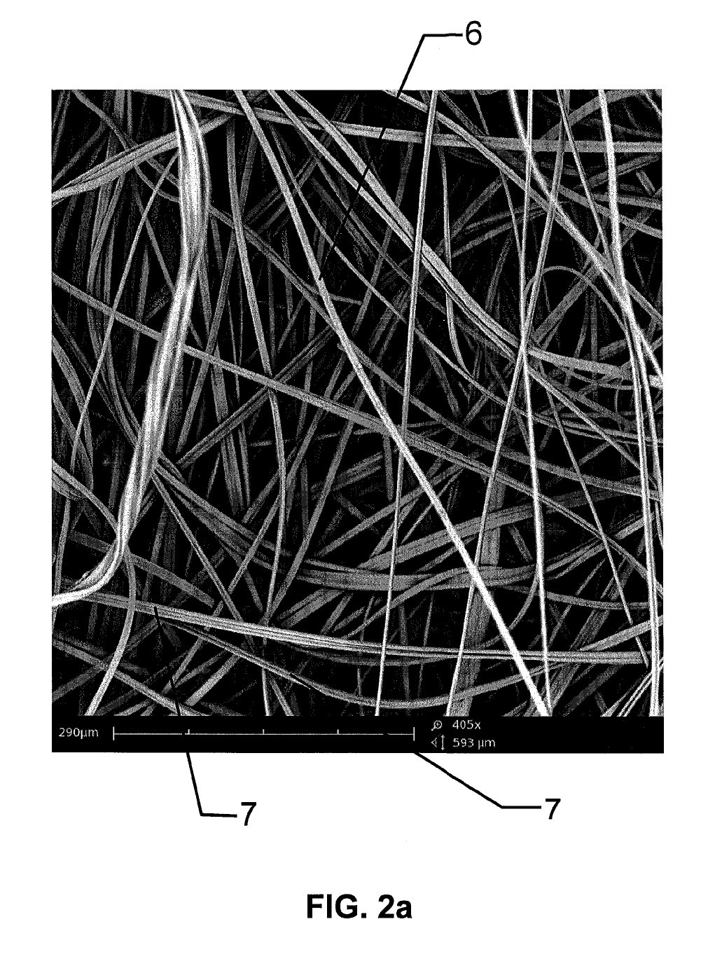

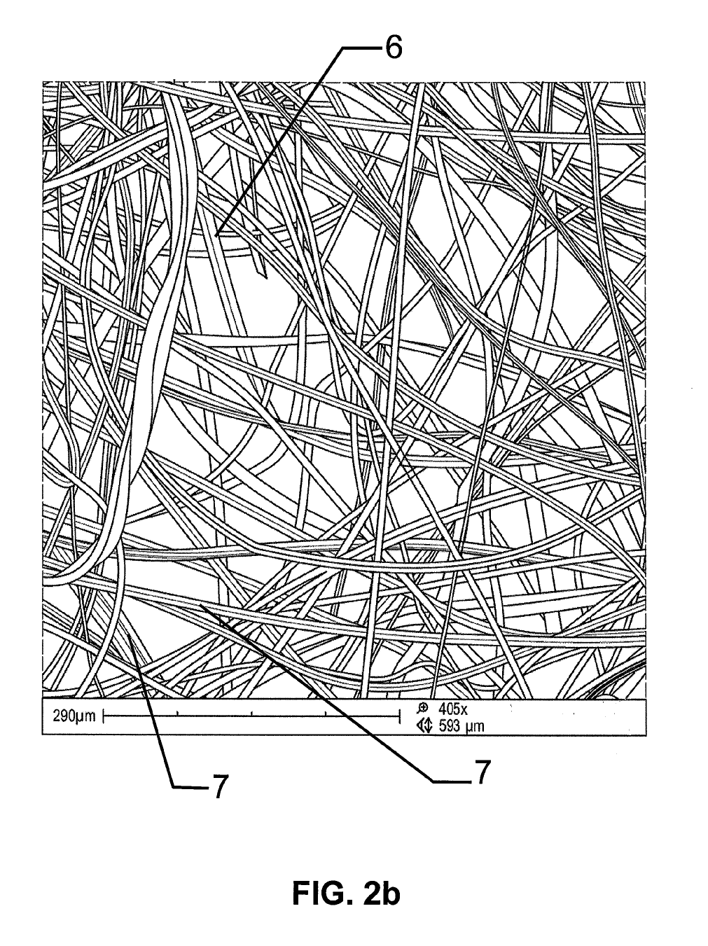

FIG. 2a is a scanning electron microscope image and FIG. 2b is a partly schematic representation of a cross section through a filter medium according to a second embodiment of the invention;

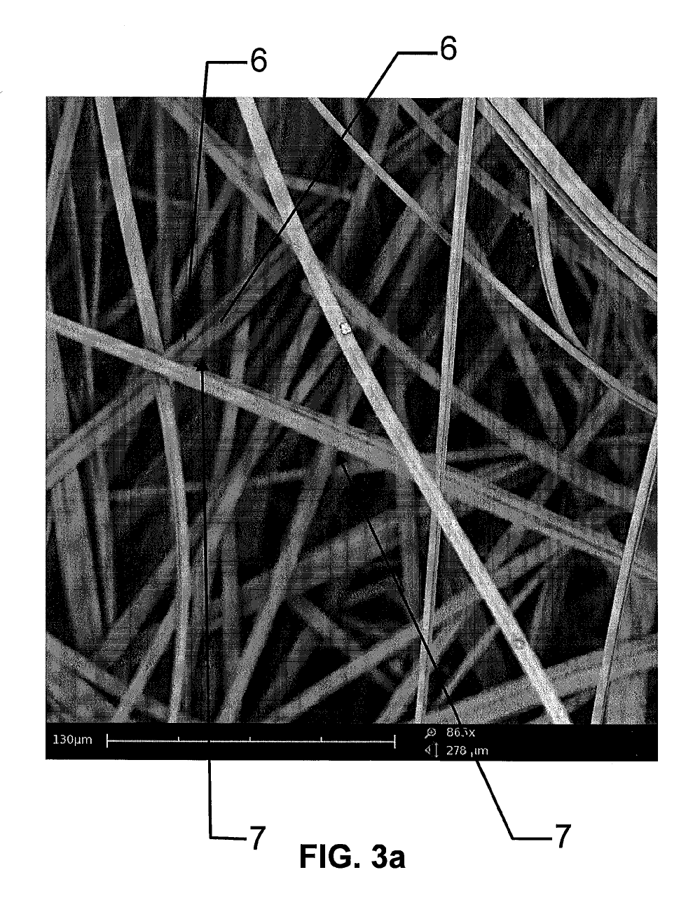

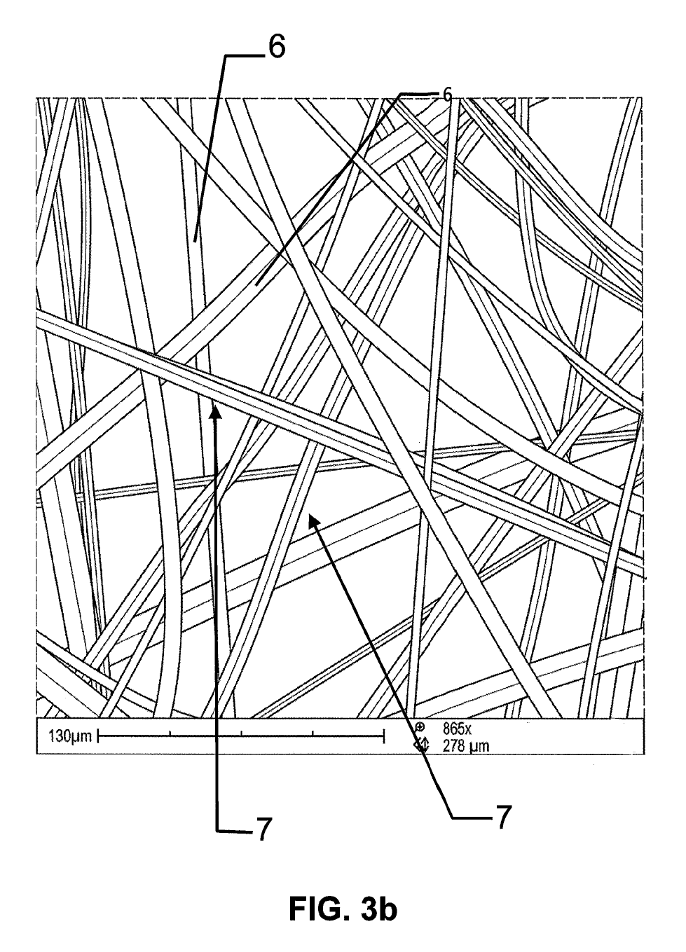

FIG. 3a is a scanning electron microscope image and FIG. 3b is a partly schematic representation of a pleated filter medium according to the second embodiment of the invention;

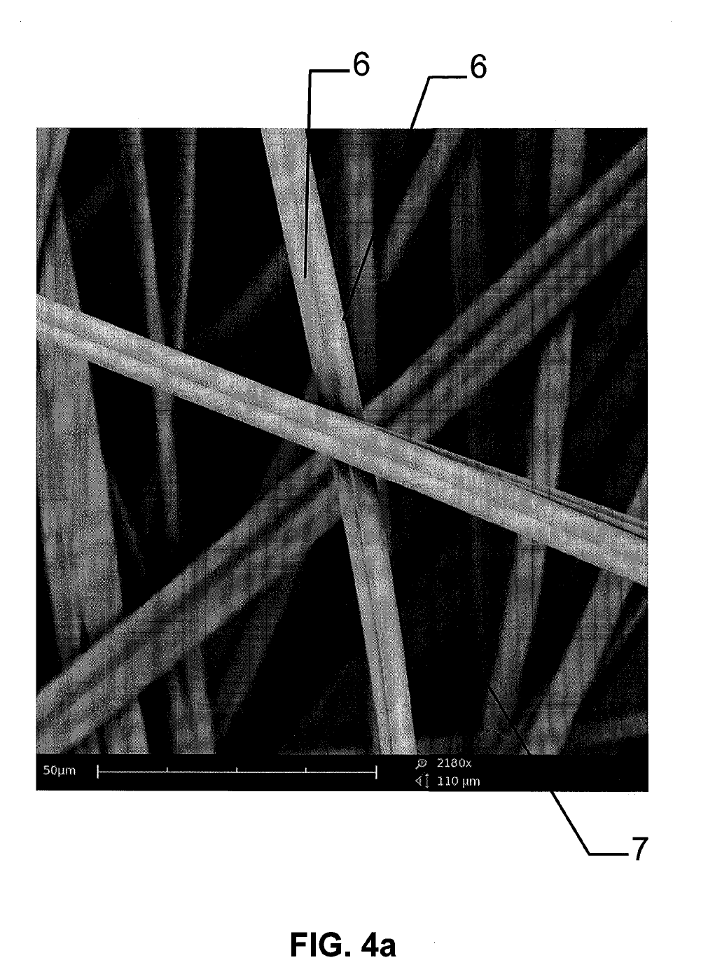

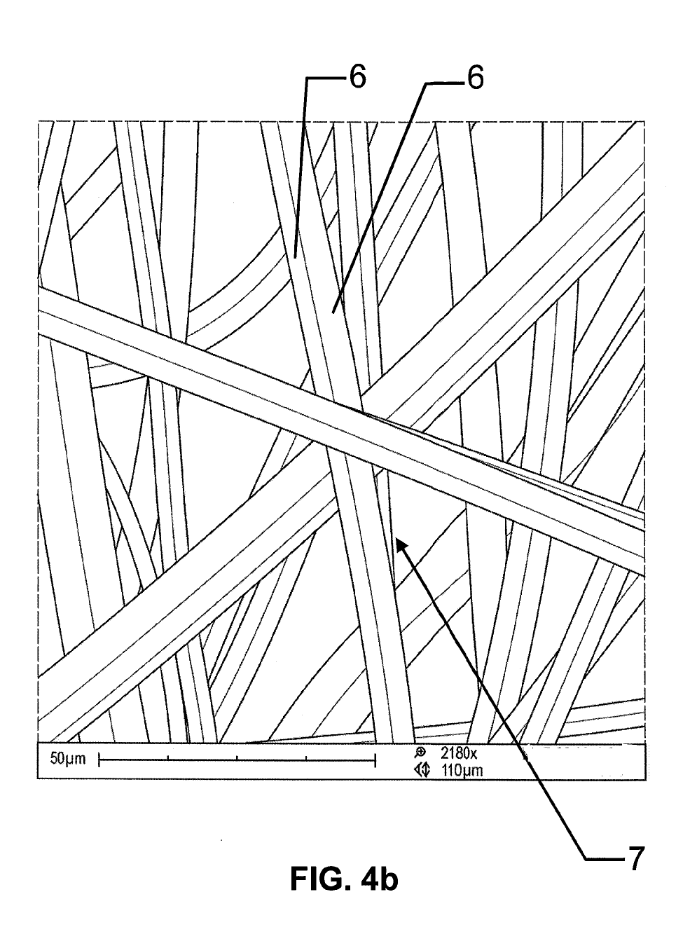

FIG. 4a is a scanning electron microscope image and FIG. 4b is a partly schematic depiction of an electron micrograph of a first layer of nonwoven;

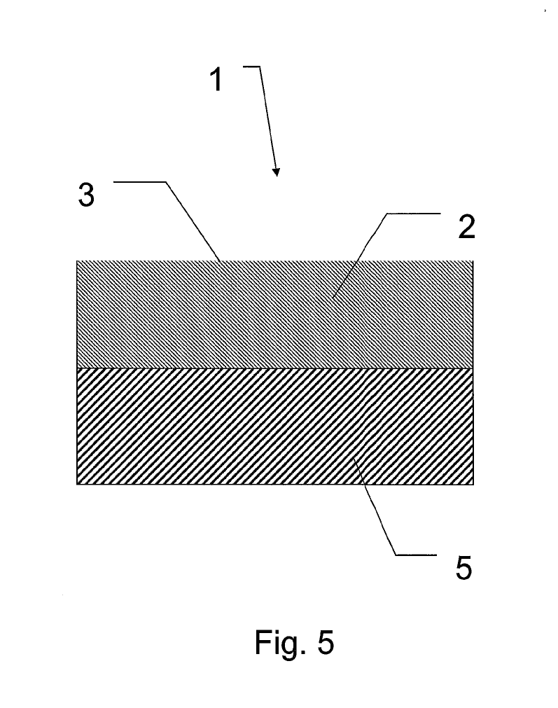

FIG. 5 is a schematic depiction of an electron micrograph of a first layer of nonwoven;

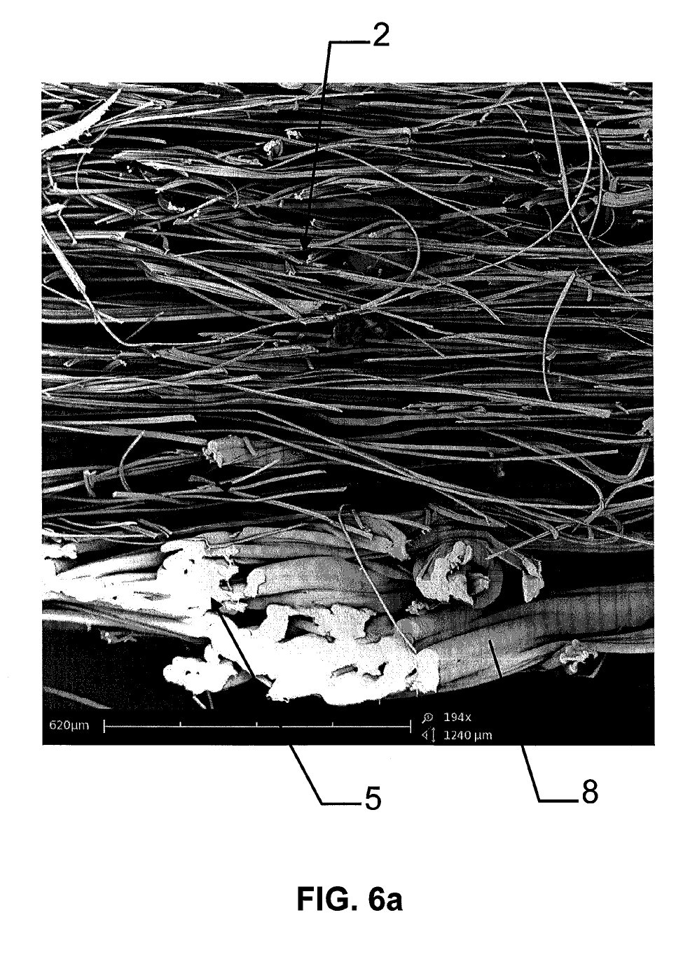

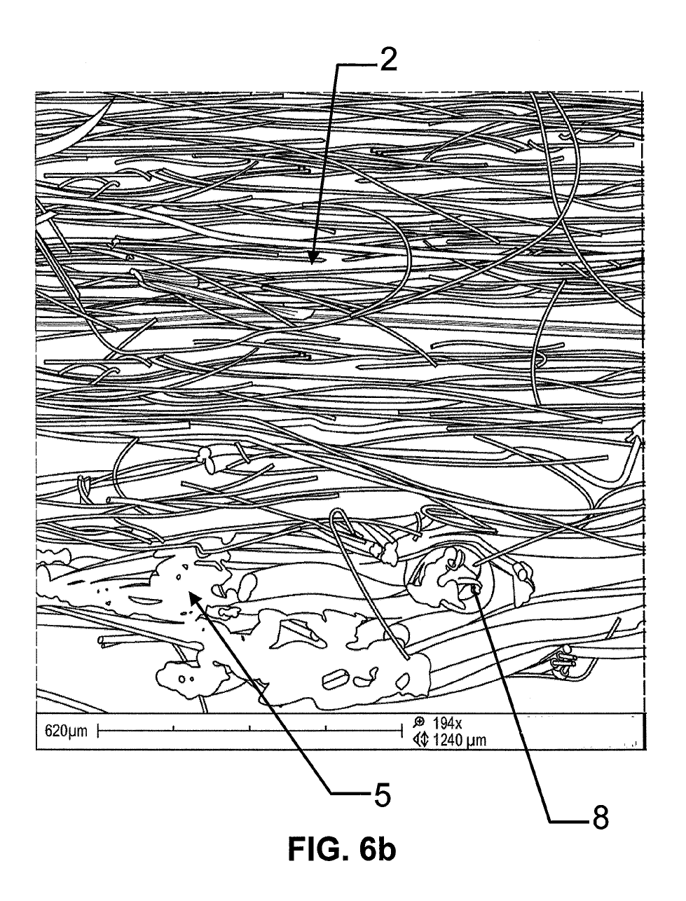

FIG. 6a is a scanning electron microscope image and FIG. 6b is a partly schematic depiction of an electron micrograph of a first layer of nonwoven;

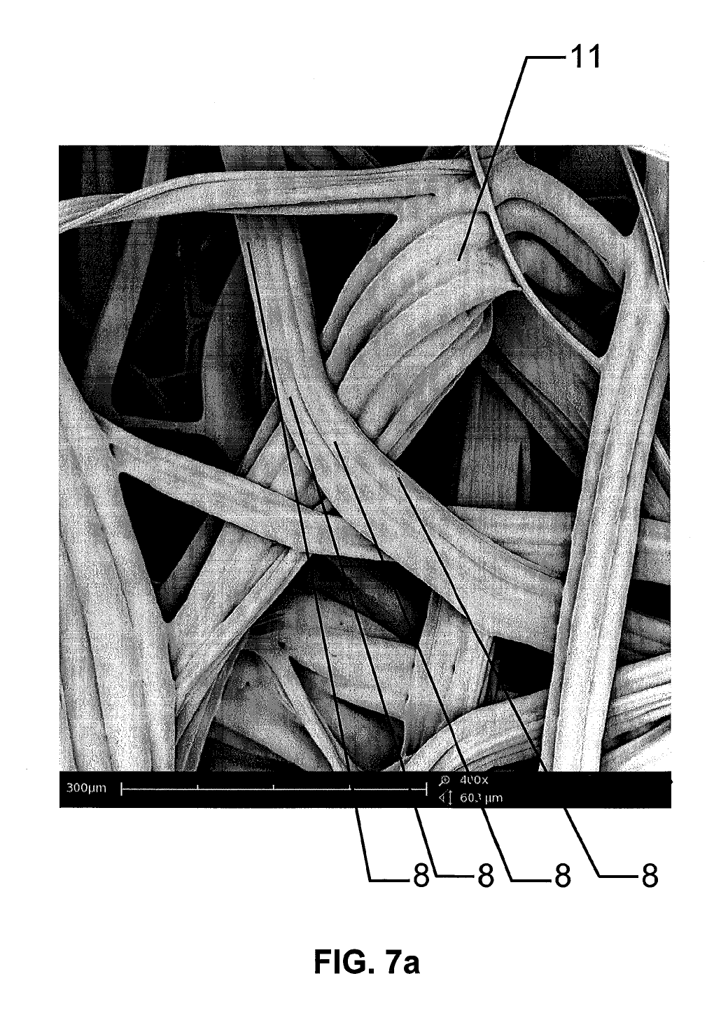

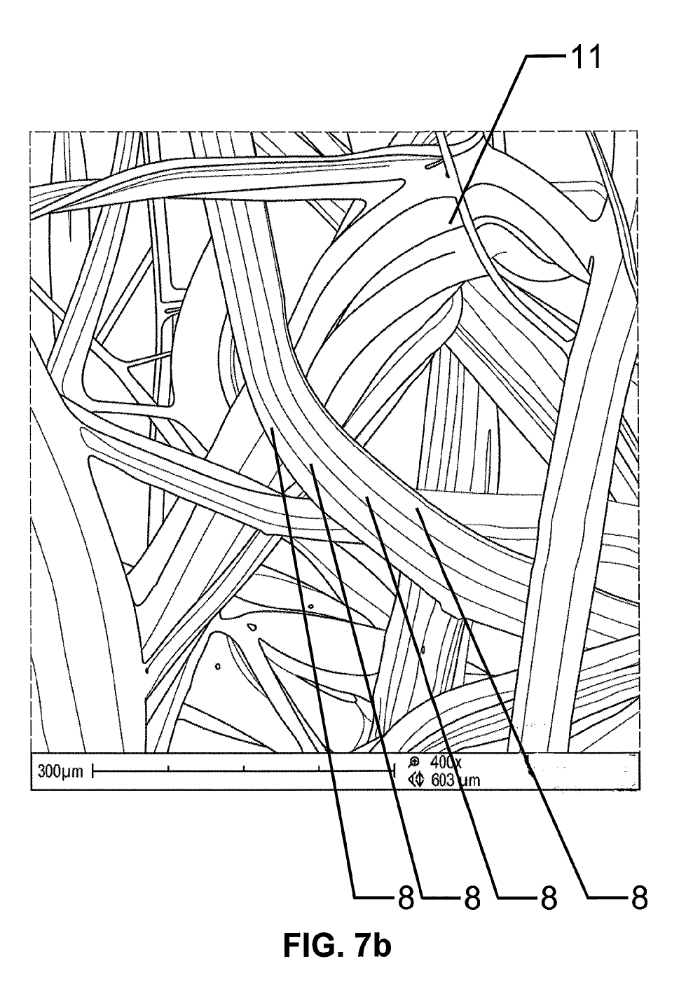

FIG. 7a is a scanning electron microscope image and FIG. 7b is a partly schematic depiction of an electron micrograph of a cross section through a filter medium according to the second embodiment of the invention;

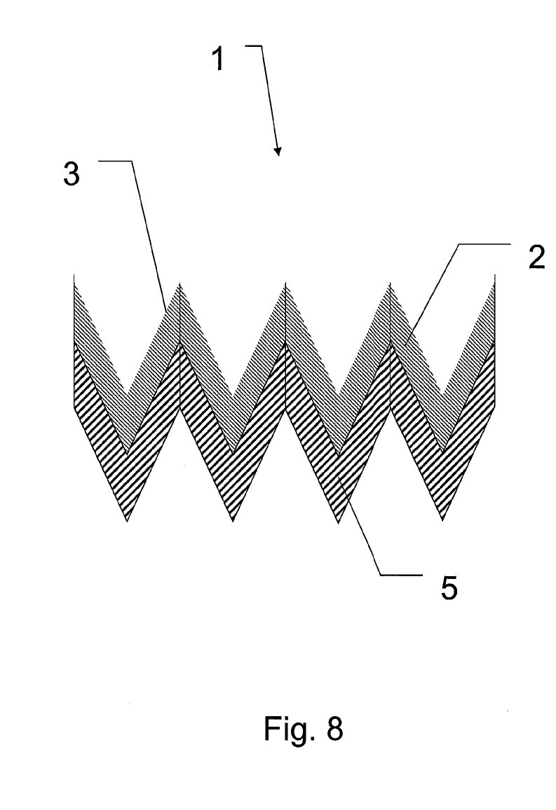

FIG. 8 is a schematic depiction of an electron micrograph of a second layer of nonwoven according to the present invention.

Reference will be made to FIG. 1 in describing a preferential filter medium 1 in greater detail.

The inventive filter medium 1 comprises a first layer of nonwoven 2 produced in a melt-spinning process. The first layer of nonwoven 2 consists preferably of a polymer having a melt flow index of 20-200, preferably 40-100, and more preferably of 60. The melt flow index is thereby preferably determined pursuant to DIN EN ISO 1133.

The following typical test conditions preferably apply when determining the MFI of specific plastics:

| Test | | | | | | | |
|---|---|---|---|---|---|---|---|
| temper- | | | | | | | |
| ature/ | Test load/kg | | | | | | |
| ° C. | 0.325 | 1.2 | 2.16 | 3.8 | 5 | 10 | 21.6 |
| 125 | EVA | | | | | | |
| 150 | | | EVA | | | | |
| 190 | | | PE | | PE | | PE |
| | | | EVA | | PP | | WPC |
| | | | POM | | | | |
| 200 | | | | | PS | | |
| 220 | | | | | | ABS | |
| | | | | | | SAN | |
| | | | | | | ASA | |
| 230 | | | PP | PMMA | PP | | |
| | | | | PMMI | PVDF | | |
| 235 | | | PA-12 | | PA-12 | PA-11 | |
| | | | PA-11 | | PA-11 | | |
| 250 | | | PBT | | | | |
| 260 | | | PBT | | PMP | | PMMI |
| 275 | | | | | PA | | |
| 280 | | PPE/PS | PET | PPE/PS | PPE/PS | | |
| | | | PPE/PS | | | | |
| 300 | | PC | PPE/PS | | PA-GF | PPE/PS | |
| | | | | | PPE/PS | | |
| 315 | | | | | PPS | | |
| 330 | | | PC | | | PA6T | |
| 340 | | | PC | | | PEI | |
| 343 | | | PSU | | | | |
| 360 | | | | | | PES | |
| | | | | | | PPSU | |
| | | | | | | PSU | |
| 400 | | | PES | | | | |
| | | | PPSU | | | | |
| | | | PEEK | | | | |

The melt flow index is thereby preferably determined with the melt mass flow rate unit at g/10 min.

A first surface 3 of the nonwoven preferably has a fleecy or soft surface area. This means that the surface 3 exhibits considerable “softness.” This “softness” can be characterized by the fleeciness, elasticity, compressibility, burst strength to a penetrating body per DIN ISO 12625-9, thickness per DIN ISO 12625-3, mass density as per DIN ISO 12625-6:2005, abrasion and/or tensile strength in a tensile test as per DIN 12625-4. Preferably, the fleecy haptics can also be determined by a test person feeling the surface structure of the first surface 3. Preferably the second surface 4 of the first layer 2 also has fleecy haptics. Particularly preferably, however, the second surface 4 is rather smooth, since in a melt-spinning process to produce the filter medium 1, the first layer 2 is normally deposited atop the second surface 4, whereby same takes the form of the substrate.

The volume density of the first layer 2 preferably amounts to between 0.01 and 0.12 g/cm³; particularly preferably between 0.03 and 0.10 g/cm³, and most preferably 0.07 g/cm³. This is a rather low density for a filter medium 1 of the type cited.

The fiber thickness of the fibers of the first layer preferably amount to 3 μm to 10 μm and particularly preferably 4 μm to 5 μm. The relatively low fiber thickness to the first layer 2 achieves a sufficiently large enough surface of fibers to ensure electrostatic capacity of said first layer 2. Preferably, the filtration efficiency of the first layer of nonwoven 2 prior to applying the charge amounts to substantially 5% to 50%, preferably 10% to 30%, preferably 15% to 20%, and subsequent to application of the static charge, substantially 50% to 95%, preferably 60% to 90%, even more preferably 70 to 80%, and most preferably 75%. Further preferably, the first layer of nonwoven 2 has a mass density (mass per unit area) of approximately 35 g/m² to 60 g/m², preferably of approximately 40 g/m² to 55 g/m², particularly preferably approximately 45 g/m² to 50 g/m², and most preferably approximately 47.5 g/m². Further preferably, the first layer of nonwoven 2 has a thickness of approximately 0.4 mm to 0.7 mm, preferably of approximately 0.5 mm to 0.6 mm, and most preferably approximately 0.55 mm. Further preferably, the first layer of nonwoven 2 has an air permeability of approximately from 800 l/m²s to 1300 l/m² s, preferably approximately from 900 l/m² s to 1200 l/m² s and most preferably approximately 1000 l/m² s. Further preferably, the first layer of nonwoven 2 has an average pore size of more than 10 μm to 60 μm, preferably from 20 μm to 50 μm, preferably from 30 μm to 40 μm, and most preferably of 35 μm. Further preferably, the first layer of nonwoven 2 is produced at a polymer processing temperature approximately from 230° C. to 280° C., preferably approximately from 240° C. to 270° C., and most preferably approximately from 250° C. to 260° C.

The respective limit values only indicate an approximate range; values which are proximate to the cited values are also conceivable in realizing the inventive teaching.

A preferably electrostatic charge is applied to the first layer of nonwoven 2 particularly by corona discharge or a triboelectric process step.

FIGS. 2a and 2b schematically depict the structure of the first layer 2 magnified under an electron microscope. According thereto, the individual fibers 6 are for the most part preferably arranged into fiber bundles 7. The distance between respective fibers 6 or fiber bundles 7 respectively is relatively large such that large interstices result between the fibers. A large portion of the fiber bundle 7 consists of two to four fibers, whereby a fiber bundle can also be formed with more fibers. Preferably, 80% to 100%, particularly preferably 80% to 90% of the fibers are arranged in fiber bundles. In one preferential embodiment, all of the fibers 6 are composed of a polymer. A further preferential embodiment has fibers of differing polymers. A further preferential embodiment comprises fiber bundles 7 consisting of fibers 6 of differing polymers and/or polymer blends. Tests have shown that particularly polypropylene having an MFI reflective of the above-cited values is particularly well-suited for the first layer.

The fiber bundles 7 are formed in the primary forming method of the melt-spinning process by the close arrangement of the spray nozzles.

FIGS. 3a and 3b depict the first layer 2 further magnified under an electron microscope. The magnification ratio is higher in FIGS. 3a and 3b than in FIGS. 2a and 2b. The individual fibers 6 as well as the fiber bundles 7 of at least two fibers and preferably of two to four fibers are again clearly visible.

FIG. 4a shows a scanning electron microscope image and FIG. 2 a schematic depiction of the magnified first layer 2 under the scanning electron microscope at even further magnification. Here as well, the fiber bundles and fibers are clearly visible.

Reference will be made to FIG. 5 is describing a filter medium according to the second embodiment of the invention in greater detail. The filter medium 1 now comprises a first layer 2 and a second layer 5. The configurations of the second embodiment can be, if technically possible, combined in any manner with those of the first embodiment.

Preferably, the fibers of the second nonwoven layer are interlaced together in a boundary layer. The interlacing thereby ensues during the primary forming process. In the process, the individual layers are sprayed from different spin beams onto a substrate moving transversely to same. When the jets are sprayed immediately one after the other or even into each other, a boundary layer results comprising fibers of both layers at different concentrations and in which the fibers are intertwined and tangled.

The first layer 2 and the second layer 5 preferably each consist of a synthetic polymer of at least one polymer from among the group of polyethylene (PE), polyethylene terephthalate (PET), polycarbonate (PC), polyamide (PA), polybutylene terephthalate (PBT), polypropylene (PP), polyester and/or polyvinyl chloride (PVC).

The fibers can be of the same synthetic polymer or different polymers or of respective blends of different polymers.

The second layer 5 of the filter medium 1 preferably has a volume density of from 0.12 to 0.20 g/cm³; preferably from 0.15 to 0.18 g/cm³, and thus preferably a higher density than the first layer 2. The fibers 8 of the second layer 5 are also preferably thicker than the fibers 6 of the first layer 2 and preferably have a fiber thickness of from 7 μm to 25 μm, more preferably from 10 μm to 20 μm, and particularly preferably of from 15 μm to 18 μm.

The respective limit values only indicate an approximate range; values which are proximate to the cited values are also conceivable in realizing the inventive teaching.

The second layer 5 preferably does not have any electrostatic charge. Particularly preferably, however, an electrostatic charge is applied to the second layer 5. This preferably occurs in the same step of the manufacturing process as the charging of the first layer 2, particularly preferably also by corona discharge or a triboelectric method.

The first layer 2 and/or the second layer 5 of the filter medium 1 is hydrophobic. In particular, the filter medium 1 can preferably be washed out, thereby regenerating same.

FIGS. 6a and 6b show a scanning electron microscope image and a schematic of a scanning electron microscope image of the filter medium 1 according to the second embodiment of the invention. The first layer 2 and the second layer 5 are clearly visible. The fibers of the individual layers are predominantly arranged in the same perpendicular direction to the surface of the filter medium 1. This orientation to the fibers 6 of the first layer 2 and the fibers 8 of the second layer 5 result particularly from the speed of a conveyor belt or substrate respectively on which the polymer(s) is/are deposited in the primary forming method of the filter medium 1. The second layer 5 also exhibits fiber bundles 9 formed from a plurality of fibers 8 of said second layer 5. Both the fibers 6 of the first layer 2 as well as the fibers 8 of the second layer 2 are preferably loose, mingled and even more preferably bonded together to form the fiber bundles 7, 9. The bonding has thereby already preferably occurred in the primary forming process. It is also conceivable for the individual fibers 6, 8 of a fiber bundle 7, 9 to be partially bonded together, only partially loose and partially or in sections separate from each other. The bonding of the fibers 6, 8 into fiber bundles 7, 9 can also ensue in a later method step, particularly by heating.

The fibers of the first layer 2 are preferably interlaced and/or joined with the fibers of the second layer 5 in an intermediate area 10 between said first layer 2 and second layer 5 such that the first layer 2 and the second layer 5 adhere to one another.

FIGS. 7a and 7b show a schematic magnification of the second layer 5 and a schematic of the same magnification under the scanning electron microscope. The fiber bundles 9 of two or more fibers of the second layer 5, 8 are clearly visible. More junction points 11 can further be seen compared to the first layer 2, in which individual fiber bundles 9 converge and are preferably bonded together. Preferably, 80% to 100%, particularly preferably 80% to 90% of the fibers of the first layer 2 and/or the second layer 5 consist of fiber bundles of at least two fibers. The second layer 5 serves in particular to stabilize the filter medium 1. This is achieved by the thicker fibers 8.

Particularly achieved by the stabilizing of the filter medium 1 is that the filter medium 1 is palatable, as shown in FIG. 8. The second layer 5 thereby supports the first layer 2.

Preferably, the second layer 5 has no or only minimal filtering effect, whereas the first layer 2 is preferably primarily responsible for the filtering effect of the filter medium 1. In another preferential embodiment, however, both layers 2, 5 serve as filter material, whereby the layers 2, 5 are preferably designed so as to respectively filter different particle sizes in each case.

The resulting filter medium 1 has a filtration efficiency of preferably approximately 5% to 20% without electrostatic charge and a filtration efficiency of preferably approximately 60% to 90% with electrostatic charge. This is a surprisingly high filtration efficiency variable for both embodiments, with and without electrostatic charge, and is based particularly on the structure of the first layer 2. Preferably, both of the depicted embodiments can be electrostatically regenerated; i.e. an electrostatic charge can be reapplied to the filter medium 1 after same loses electrostatic charge. In contrast, the filtration efficiency of the second layer 5 without the first layer 2 is only at approximately 40%.

The filtration efficiency is hereby determined using conventional measuring methods. Preferentially, the filtration efficiency is determined with sodium chloride particles of 0.4 μm at a flow rate of V=0.14 m/sec.

FIG. 8 shows a schematic representation of a pleated filter medium 1. Because of the stabilization by the second, more rigid layer 5, the filter medium 1 readily folds and the first surface 3 serves preferably as the filter surface subject to the flow.

The inventive effect can also be achieved with values at the peripheral of the respectively specified ranges. Moreover, all the cited parameters are average values which can deviate significantly at certain points in the respective layers.

### LIST OF REFERENCE NUMERALS

1 filter medium
2 first layer of nonwoven
3 first surface
4 second surface
5 second layer of nonwoven
6 fiber (first layer)
7 fiber bundle (first layer)
8 fiber (second layer)
9 fiber bundle (second layer)
10 intermediate area
11 junction point

1. A filter medium (1) made from a first synthetic polymer comprising a first layer of nonwoven (2) produced in a melt-spinning process, wherein an electrostatic charge can be applied to the first layer of nonwoven (2), and wherein the polymer has a melt flow index of from 20 to 200, preferably from 40 to 100, and even more preferably of 60.

2. The filter medium (1) according to claim 1, wherein the fleeciness, elasticity, compressibility, burst strength to a penetrating body, thickness, mass density, abrasion and/or tensile strength pursuant a tensile test of the first layer of nonwoven is provided such that at least one first surface (3) of the first layer of nonwoven (2) exhibits fleecy haptics.

3. The filter medium (1) according to claim 1, wherein the filtration efficiency of the first layer of nonwoven (2) prior to applying the charge amounts substantially to 5% to 50%, preferably 10% to 30%, preferably 15% to 20%, and after applying the static charge, substantially to 50% to 95%, preferably 60% to 90%, more preferably 70 to 80% and most preferably 75%.

4. The filter medium (1) according to any one of the claim 1, wherein the first layer of nonwoven (2) has a mass density of approximately 35 to 60 g/m², preferably approximately from 40 to 55 g/m², particularly preferably approximately from 45 to 50 g/m² and most preferably approximately 47.5 g/m².

5. The filter medium (1) according to claim 1, wherein the first layer of nonwoven (2) has a thickness of approximately from 0.4 mm to 0.7 mm, preferably approximately from 0.5 mm to 0.6 mm and most preferably approximately 0.55 mm.

6. The filter medium (1) according to claim 1, wherein the first layer of nonwoven (2) has an air permeability of approximately 800 l/m² s to 1300 l/m² s, preferably approximately from 900 l/m² s to 1200 l/m² s, and most preferably approximately 1000 l/m² s.

7. The filter medium (1) according to claim 1, wherein the first layer of nonwoven (2) has an average pore size of from more than 10 μm to 60 μm, preferably from 20 μm to 50 μm, preferably from 30 to 40 μm, and most preferably 35 μm.

8. The filter medium (1) according to claim 1, wherein the first layer of nonwoven (2) is produced at a polymer processing temperature of approximately 230° C. to 280° C., preferably approximately 240° C. to 270° C., and most preferably approximately from 250° C. to 260° C.

9. The filter medium (1) according to claim 1, wherein 50% to 100% and preferably 80% to 90% of the fibers of the first layer (2) are arranged in fiber bundles (7) of at least two fibers.

10. The filter medium (1) according to claim 1, wherein the first layer exhibits a volume density between 0.01 g/cm³ and 0.12 g/cm³, preferably between 0.03 g/cm³ and 0.1 g/cm³, and most preferably 0.07 g/cm³.

11. The filter medium (1) according to claim 1, wherein the fibers (6) of the first layer (2) predominantly have a thickness of from 3 μm to 10 μm and preferably from 4 μm to 5 μm.

12. The filter medium (1) according to claim 1 comprising a second layer of nonwoven (5) for stabilization made from the first and/or a second polymer, particularly for producing pleatability.

13. The filter medium (1) according to claim 12, wherein fibers of the first layer of nonwoven (2) and fibers (6, 8) of the second layer of nonwoven (5) are interlaced together in a boundary layer.

14. The filter medium (1) according to claim 12, wherein the second layer of nonwoven (5) has a higher volume density than the first layer (2), particularly of from 0.12 to 0.2 g/cm³ and preferably from 0.15 to 0.18 g/cm³.

15. The filter medium (1) according to claim 12, wherein the second layer (5) has thicker fibers (8) than the first layer (2), particularly at a fiber thickness of from 7 μm to 25 μm, preferably from 10 μm to 20 μm, and particularly preferably 15 μm to 18 μm.

16. The filter medium (1) according to claim 12, wherein the synthetic first and/or second polymer is at least one polymer selected from among the group of polyethylene (PE), polyethylene terephthalate (PET), polycarbonate (PC), polyamide (PA), polybutylene terephthalate (PBT), polypropylene (PP) and/or polyvinyl chloride (PVC).

17. The filter medium (1) according to claim 12, wherein 50% to 100%, preferably 80% to 100%, and particularly preferably 80% to 90% of the fibers of the first layer (2) and/or the second layer (5) are arranged in fiber bundles of at least two fibers (6, 8).

18. The filter medium (1) according to claim 12, wherein the first layer (2) and/or the second layer (5) has fiber bundles of different synthetic polymer fibers.

19. The filter medium (1) according to claim 12, wherein the individual fibers (6, 8) and/or the fiber bundles (7, 9) of the first layer and/or the second layer (5) are arranged predominantly parallel.

20. The filter medium according to claim 12, wherein the first layer (2) and/or the second layer (5) is hydrophobic.

21. The filter medium according to claim 12, wherein the first layer (2) and/or the second layer (5) is designed such that the filter medium has a differential pressure of less than 70 Pa, preferably of less than 60 Pa.

22. A filter having a filter medium in accordance with claim 1.

23. The filter medium (1) according to claim 1, wherein the synthetic first polymer is at least one polymer selected from among the group of polyethylene (PE), polyethylene terephthalate (PET), polycarbonate (PC), polyamide (PA), polybutylene terephthalate (PBT), polypropylene (PP) and/or polyvinyl chloride (PVC).

24. The filter medium (1) according claim 1, wherein the first layer (2) has fiber bundles of different synthetic polymer fibers.

25. The filter medium (1) according to claim 1, wherein the individual fibers (6, 8) and/or the fiber bundles (7, 9) of the first layer are arranged predominantly parallel.

26. The filter medium according to claim 1, wherein the first layer (2) is hydrophobic.

27. The filter medium according to claim 1, wherein the first layer (2) is designed such that the filter medium has a differential pressure of less than 70 Pa, preferably of less than 60 Pa.
